(19) United States
(12) Patent Application Publication
(10) Pub. No.: US 2014/0278888 A1
(43) Pub. Date: Sep. 18, 2014

(54) METHOD AND SYSTEM FOR OFFERING SPENDING-BASED REWARDS

(71) Applicant: Capital One Financial Corporation, McLean, VA (US)

(72) Inventors: David A. PINSKI, Narberth, PA (US); John YUNG, Wilmington, DE (US)

(73) Assignee: Capital One Financial Corporation, McLean, VA (US)

(21) Appl. No.: 14/206,330

(22) Filed: Mar. 12, 2014

Related U.S. Application Data
(60) Provisional application No. 61/782,971, filed on Mar. 14, 2013.

(51) Int. Cl. G06Q 30/02

(52) U.S. Cl. CPC G06Q 30/0226
USPC 705/14.27

(57) ABSTRACT

A system and method in accordance with example embodiments may include evaluating account holder data, determining an account holder specific rewards program, and providing the account holder specific rewards program to the account holder. The rewards program may include a rewards and/or cash-back eligibility for a number of rewards or cash-back options.

### CROSS-REFERENCE TO RELATED APPLICATIONS

This application claims priority to U.S. Provisional Patent Application No. 61/782,971, filed on Mar. 14, 2013, the entire contents of which is incorporated herein by reference.

### FIELD OF THE DISCLOSURE

The present disclosure relates to methods and system for providing spending-based rewards and/or offers.

### BACKGROUND OF THE DISCLOSURE

Credit card providers provide rewards or cash-back programs that remain generic for a particular spending card, such as a credit card. The specifics of these programs are typically not individualized to a specific consumer, but instead are program-wide. Thus, an individual's spending and/or the type of card will determine what redemption options are available. Also, point valuations are set at an earnings level, and not the spending level for a given points program. That is, the points earned by a consumer have a valuation set at the program level and are not customer-specific. These and other drawbacks exist.

### SUMMARY OF THE DISCLOSURE

A system for determining an account holder specific rewards redemption program includes at least one database storing account holder data and rewards data and a rewards processor that analyzes account holder data associated with an account to determine at least one account spending pattern associated with the account holder and determines, using the rewards data and the account spending pattern, an account holder specific rewards redemption program, In such a system, the account holder specific rewards redemption program is based on the at least one account holder spending pattern, the account holder specific rewards program associates the account with a particular level, and a redemption value associated with the customer specific rewards redemption program varies based on the account holder's spending.

A method for determining an account holder specific rewards redemption program includes receiving, via a network, account holder data, account data associated with the account holder, and rewards data, analyzing, using a rewards processor, the account holder data to determine at least one account holder spending pattern, determining, using the rewards processor, an account holder specific rewards redemption program, and transmitting, via a network, the account holder specific rewards program to the account holder. In such a method, the account holder specific rewards redemption program is based on the at least one account holder spending pattern, the account holder specific rewards program associates the account with a particular level, and a redemption value associated with the customer specific rewards redemption program varies based on the account holder's spending

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts an example embodiment of a system implementing a spending-based rewards program according to an embodiment of the disclosure;

FIG. 2 depicts an example embodiment of a method for providing a spending-based rewards program according to an embodiment of the disclosure.

### DETAILED DESCRIPTION OF THE EMBODIMENTS

The following description is intended to convey a thorough understanding of the embodiments described by providing a number of specific example embodiments and details involving systems and methods for offering spending-based rewards. It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in various embodiments, depending on specific design and other needs. A financial institution and system supporting a financial institution are used as examples for the disclosure. The disclosure is not intended to be limited to financial institutions only.

According to the various embodiments of the present disclosure, systems and methods enable providing spending-based rewards. Account providers such as, for example, credit and/or debit card issuers and the like, may provide rewards and/or offers, such as cash-back offers, or similar programs based on a spending level associated with an account. For example, a financial institution may provide a credit card account to a consumer and based on the consumer's spending level, determine an optimal or desired reward and/or offer, or the like, to provide to the account holder. These optimal or desired rewards may be linked to a particular reward level or tier, where the consumer's spending level is within that particular reward level or tier.

Account providers may utilize any of the large amount of consumer data that the account provider maintains or has access to. For example, the account provider may use a consumer's income information, transaction information, demographic information, credit history information, rewards redemption information, cash-back information, offer information, or any other information. From this information, an account provider may derive a consumer-specific rewards redemption or cash-back program.

By way of example, the account provider may maintain one or more databases to store account holder data. Additionally, the account provider may have access to additional data sources to obtain data regarding its account holders. The additional data sources may be, for example, financial institution data sources, merchant data sources, credit reporting data sources, social networking data sources, as well as others.

In an example embodiment, an account provider may receive account holder data from its own database as well as external data sources. The account holder data then may be evaluated in order to determine a rewards and/or cash-back or other offer eligibility for a number of rewards and/or offer options.

In an example embodiment, the account holder data may be evaluated in order to determine a rewards and/or offer eligibility for a number of rewards or cash-back options where the rewards and/or offer options may be determined based on a tiered program provided by the account provider. The tiered program provided by the account provider may have various levels where each level is associated with a threshold spending amount. Each level may be available to an account holder that has at least the level-defined spending amount associated with his or her account.

In an example embodiment, the account holder data may be evaluated in order to determine a rewards and/or offer eligibility for a number of rewards and/or offer options where the evaluation of the account holder data is a dynamic evaluation such that rewards and/or offer options are evaluated on either a continuous, scheduled, or triggered basis.

In an example embodiment, the account holder data may be evaluated in order to determine a rewards and/or offer eligibility for a number of rewards and/or offer options where the determined rewards and/or offer options are further optimized by the inclusion of a spending/redemption behavior analysis. The spending/redemption behavior analysis may take into consideration past spending habits, rewards and/or offer redemption history, as well as any other spending or redemption-related behaviors in order to provide optimal redemption and/or offers to an account holder.

In an example embodiment, the account holder data may be evaluated in order to determine a rewards and/or cash-back or other offer eligibility for a number of rewards and/or cash-back or other offer options where the determined rewards and/or cash back or other offers are communicated to the consumer. This communication to the consumer may be done in a variety of forms including, but not limited to, mail, e-mail, SMS, MMS, voicemail, telephone call, and/or through a social networking platform or any mobile device application.

In an example embodiment, the account holder data may be evaluated in order to determine a rewards and/or cash-back or other offer eligibility for a number of rewards and/or cash-back or other offer options where rewards and/or cash-back eligibility may be time-dependent, such that the rewards and/or cash-back or other offer eligibility may expire or may contain an expiration date.

FIG. 1 depicts an example system 100 for providing spending-based rewards and/or cash-back offers or other offers. System 100 may include an account provider 102, a social networking system 110, a merchant system 112, a user device 114, and a network 116. While each element of system 100 is depicted as a single element, it should be appreciated that according to one or more embodiments, each element may comprise a plurality of elements, such as, for example, a plurality of user devices 114, a plurality of merchant systems 112, a plurality of social networking systems 110, a plurality of account providers 102, and a plurality of networks.

Each component of system 100 is an example and while a singular account provider 102, social networking system 110, merchant system 112, user device 114, and network 116 are provided, each may actually be more than one.

Each account provider 102 may be in communication with the system 100. Each account provider 102 may also contain a database 104, an offers and rewards module 106 and a communication module 108. By way of example, each module may include the necessary hardware, software, and firmware to enable the functionality of the module. The account provider may provide a variety of accounts, where the accounts may be, for example, a prepaid card account, stored value card account, debit card account, check card account, payroll card account, gift card account, prepaid credit card account, charge card account, checking account, rewards account, line of credit account, or credit account, or any other account for financing a transaction in a commercial system 100. Example account providers 102 may include issuers, such as credit and debit card issuers that issue credit and/or debit cards to account holders. The cards issued by an issuer may have an associated rewards program such as, for example, the spending-based rewards program shown and described herein.

An account provider database 104 may include data pertaining to one or more account holders, one or more rewards and/or cash-back or other offer programs, as well as other information. This information may include, but is not limited to, account holder name, address, social security number, income information, transaction information, demographic information, credit history information, rewards redemption information, cash-back information, rewards program information, cash-back program information, merchant information, social networking information, and any other information necessary for system 100. Moreover, this information may be stored internally within the account provider system 102 in a database 104, or, alternatively, all or portions of this information may reside in a database external to the account provider system 102 or retrieved or otherwise obtained from an external data source, such as, for example, a social networking system 110 or a merchant system 112.

Offer and rewards module 106 may enable the evaluation of data held in database 104 or other external data sources (not shown) and determination of a rewards and/or cash-back or other offer eligibility for account holders. Offer and rewards module 106 may further determine any additional offers or the like to provide to account holders. Offer and rewards module 106 may include hardware, software, and firmware that may enable evaluations and determinations, as well as, for example, delivery of offers and/or rewards to communication module 108. Offer and rewards module also may include one or more processor that comprise, for example, a rules-based engine that enables, for example, a rules-based analysis of account holder data so that a customer-specific, spending-based rewards program may be established for each account holder. In various example embodiments, the rules-based engine may enable the establishment of rewards program for each account holder that, for example, optimize future consumer spending.

Communication module 108 may enable communication between the components of system 100. Communication module 108 may include hardware, software, and firmware that may enable communication between account provider 102 and other components of system 100 using network 116, for example.

Network 116 may enable communication between an account provider 102, a social networking system 110, a merchant system 112, and a user device 114. For example, network 116 may be one or more of a wireless network, a wired network or any combination of wireless network and wired network. For example, network 116 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g or any other wired or wireless network for transmitting and receiving a data signal.

In addition, network 116 may include, without limitation, telephone lines, fiber optics, IEEE Ethernet 902.3, a wide area network (“WAN”), a local area network (“LAN”), or a global network such as the Internet. Also network 116 may support an Internet network, a wireless communication network, a cellular network, or the like, or any combination thereof. Network 116 may further include one network, or any number of the example types of networks mentioned above, operating as a stand-alone network or in cooperation with each other. Network 116 may utilize one or more protocols of one or more network elements to which they are communicatively coupled. Network 116 may translate to or from other protocols to one or more protocols of network devices. Although network 116 is depicted as a single network, it should be appreciated that according to one or more embodiments, network 116 may comprise a plurality of interconnected networks, such as, for example, the Internet, a service provider's network, a cable television network, corporate networks, and home networks.

System 100 may include an account holder device 114, which may be a mobile device. Mobile device 114 may be any mobile device capable of accessing the internet, and in the instance where the mobile device is used for mobile wallet capabilities, the mobile device 114 may be any mobile device capable of executing a payment. For example, mobile device 114 could be an iPhone, iPod, iPad from Apple® or any other mobile device running Apple's iOS operating system, any device running Google's Android® operating system, any device running Microsoft's Windows® Mobile operating system, and/or any other smartphone or like device.

Mobile device 114 may include for example, a Subscriber Identity Module (SIM) card, an NFC module, and an App Processor. The SIM card may be an integrated circuit that securely stores the service-subscriber key (IMSI) used to identify a subscriber on mobile telephony devices (such as mobile phones and computers). The NFC module may be an embedded NFC chip that can send encrypted data a short distance (“near field”) to a reader located, for instance, next to a retail cash register. The App Processor may enable execution of software applications on mobile device 114. In various embodiments, the App Processor may cooperate with the NFC module to enable a payment using mobile device 114. The App Processor of the mobile device 114 may enable executing the display, request for, and or use of rewards and/or offers, which may include various user interfaces.

Mobile device 114 may also include various software components to facilitate a rewards and/or offers application For example, mobile device 114 may include an operating system such as, for example, the iOS operating system from Apple, the Google Android operating system, and the Windows Mobile operating system from Microsoft. Mobile device 114 may also include, without limitation, software applications such as mobile banking, mobile wallet, social networking, and other applications to facilitate a rewards and/or offers application, an NFC application programming interface, and software to enable touch sensitive displays. Mobile device manufacturers may provide software stacks (e.g., APIs) which allow software applications to be written on top of the software stacks. For example, mobile device manufacturers may provide, without limitation, a card emulation API to enable NFC card emulation mode, a logic link control protocol (LLCP) API for peer-to-peer communication between mobile devices, and a real-time data (RTD) API and a NFC Data Exchange Format (NDEF) API for reading/writing.

Merchant system 112 may include a Point of Sale (PoS) device, a payment processing system, a communication module, as well as a plurality of data sources (not shown). The merchant system 112 may enable the sharing of transaction data, merchant data, rewards and/or offer data, as well as account holder data over network 116.

Social networking system 110 may include systems and modules associated with social networking providers such as Facebook, MySpace, Foursquare, and the like. Social networking system may maintain records associated with and linked to a particular account holder. These records may be communicated to the account provider system 102 via network 116.

FIG. 2 depicts an example method 200 for providing spending-based rewards and/or offers. At block 202, an account provider may receive data to enable the establishment of a customer-specific spending-based reward program. Such data may include, account holder data, including, but not limited to, account holder name, address, social security number, income information, transaction information, demographic information, credit history information, rewards redemption information, cash-back information, account holder status information; rewards program data; cash-back program data; merchant data; social networking data; and any other information necessary. Transaction information may include, for example, spending history, including spending patterns with specific merchants that may allow a financial institution to predict, for example, future spending patterns of the account holder. Other information may include rewards program data, including rewards points data and rewards redemption information. For example, the account provider may receive rewards balance information for the account holder as well as the number of points redeemed by the account holder. As referred to herein, the term points may refer to miles, points, and/or other rewards perks, for example.

At block 204, the received data may be evaluated. This evaluation may include an evaluation of the account holder data described above as well as account holder spending patterns, merchant promotions, account provider promotions, social networking promotions, and account provider liability associated with rewards, cash-back offers, and any other offer. By way of example, a liability associated with rewards, cash-back offers, and any other offer may include a value to attach to the account provider's balance sheet. In example embodiments, a rules-based analysis may be used to evaluate the spending patterns of the account holder(s) to enable a financial institution to offer, for example, specifically paired redemption options that may drive future account holder spending.

The evaluation of data (block 204) may take place at a variety of points. By way of example, this evaluation (block 204) may be a continuous evaluation, whereby with the addition of any information associated with an account holder, a new evaluation may be performed. The evaluation of data (block 204) may also take place at a scheduled time, such that the evaluation takes place at a predetermined time, day, or date. The evaluation of data (block 204) also may be triggered by a transaction, such that, for example, when an account provider is sent an authorization request for a particular account holder, an evaluation may be run for that particular account holder. The evaluation of data (block 204) also may be triggered by a change in account status. An account status may be, for example, highly active, active, minimally active, and dormant. Based on the account status, the rewards and/or offers that were previously provided to the account holder. For example, where an account status changes to dormant, or decreases in activity level, the rewards and/or offers previously offered or earned may be decreased. In this manner, rewards and/or offers are not entirely eliminated and the liability associated with the rewards and/or offers is decreased. Moreover, rewards and/or offers may be time-dependent and the end of the time associated with a particular reward and/or offer may trigger the evaluation of data (block 204).

The evaluation of data (block 204) may further include an optimization of account holder behavior, which may analyze the spending and redemption behavior of an account holder and return the optimal reward, cash-back offer, or other offer to the account holder. In various embodiments, this optimization may be based on, for example, a rules-based analysis. In this way, the offer and/or reward is more likely to be redeemed by an account holder, thereby decreasing the liability associated with the reward (e.g., the accounting for the reward and/or offer on the account provider's balance sheet).

At block 206, an offer, such as a rewards, cash-back, or other offer may be determined for a particular account holder. The rewards and/or offers may be determined using a tiered program, such that the spending patterns of a particular account holder may align with specific tier of the rewards and/or offers programs. As a result, the rewards and/or offers that may be provided are those associated with the tier which the account holder's spending patterns or other results of the evaluation are grouped. For example, where it is determined that an account holder's spending level matches or exceeds a particular threshold (e.g., $10,000), the tier associated with that threshold may provide certain rewards and/or offers. As a result, that tier's rewards and/or offers may be provided to the account holder.

By way of example, a tiered rewards and/or offer program may include levels such as silver, gold, and platinum. Each tier relates to a particular spending threshold such that, for example, a silver tier may relate to an account holder spending of $10,000 or more, a gold tier may relate to an account holder spending of $20,000 or more, and a platinum tier may relate to an account holder spending of $30,000 or more. Moreover, each tier may be associated with a particular reward and/or offer such that as spending patterns indicate that the account holder spending is increasing and the account holder may be allowed to “move up” a tier (e.g., moving from Silver status to Gold status) and the rewards and/or offers may increase. For example, rewards associated with a silver tier may be one reward point for every dollar spent, a gold tier may be associated with one and a half reward point for every dollar spent, and a platinum tier may be associated with two reward points for every dollar spent.

In addition tiers may be determined based on spending patterns, such that a spending amount associated with a particular merchant, for example a participating merchant, is worth more than a spending amount associated with another merchant, for example a non-participating merchant. Including this in the evaluation block (block 204), an account holder may be able to “move up” a tier by using his or her account to make purchases with participating merchants. For example, an account holder who spends $7,500 with a participating merchant may be associated with a silver tier, whereas an account holder who spends $7,500 with a non-participating merchant may not be associated with a silver tier. Instead, an account holder may be required to spend $10,000 at a non-participating merchant to achieve silver status.

Tiers may also be time-based, such that an account holder may only be associated with a particular tier for a predetermined amount of time, such as, for example, a year. Once that time period has passed, the account associated with the account holder may be reevaluated for spending patterns in order to determine whether or not the account may remain associated with a particular tier. Additionally, the predetermined amount of time may be a moving time block, such that when an account holder “moves up” a tier, the predetermined amount of time restarts.

At block 208, the determined reward and/or offer may be provided to the account holder. The determined reward and/or offer may be provided to the account holder at, for example, a mobile device, over a network via e-mail, SMS, MMS, voicemail, telephone call, and/or through a social networking platform or any mobile device application.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A system, comprising:
at least one database storing account holder data and rewards data; and
a rewards processor that analyzes account holder data associated with an account to determine at least one account spending pattern associated with the account holder and determines, using the rewards data and the account spending pattern, an account holder specific rewards redemption program,
wherein the account holder specific rewards redemption program is based on the at least one account holder spending pattern, the account holder specific rewards program associates the account with a particular level, and wherein a redemption value associated with the customer specific rewards redemption program varies based on the account holder's spending.

2. The system of claim 1, wherein the account holder specific rewards redemption program includes a plurality of tiers, each of the plurality of tiers having an associated tier redemption value.

3. The system of claim 2, wherein the plurality of tiers include successive tiers, each of which are associated with a higher spending amount, and wherein each of the successive tiers are associated with a higher respective redemption value.

4. The system of claim 1, further comprising a notification processor that notifies the account holder of the account holder specific rewards redemption program.

5. A method, comprising:
receiving, via a network, account holder data, account data associated with the account holder, and rewards data;
analyzing, using a rewards processor, the account holder data to determine at least one account holder spending pattern;
determining, using the rewards processor, an account holder specific rewards redemption program, wherein the account holder specific rewards redemption program is based on the at least one account holder spending pattern, the account holder specific rewards program associates the account with a particular level, and wherein a redemption value associated with the customer specific rewards redemption program varies based on the account holder's spending; and
transmitting, via a network, the account holder specific rewards program to the account holder.

6. The method of claim 5, wherein the account holder specific rewards redemption program includes a plurality of tiers, each of the plurality of tiers having an associated tier redemption value.

7. The system of claim 6, wherein the plurality of tiers include successive tiers, each of which are associated with a higher spending amount, and wherein each of the successive tiers are associated with a higher respective redemption value.

8. The method of claim 5, further comprising a notification processor that notifies the account holder of the account holder specific rewards redemption program.
